(19) United States
(12) Patent Application Publication
(10) Pub. No.: US 2018/0103134 A1
(43) Pub. Date: Apr. 12, 2018

(54) SOUND AMPLIFYING CASE FOR MOBILE PHONES

(71) Applicant: FERAS Y.A.H.A. MALALLAH, SAFAT (KW)

(72) Inventor: FERAS Y.A.H.A. MALALLAH, SAFAT (KW)

(21) Appl. No.: 15/839,715

(22) Filed: Dec. 12, 2017

Related U.S. Application Data
(63) Continuation of application No. 15/719,305, filed on Sep. 28, 2017.
(60) Provisional application No. 62/400,637, filed on Sep. 28, 2016.

(51) Int. Cl. H04M 1/03; H04M 1/02; H04M 1/04; G06F 1/16

(52) U.S. Cl. CPC H04M 1/035; H04M 1/026; G06F 2200/1633; G06F 1/1626; H04M 1/04

(57) ABSTRACT

A sound amplifying case for supporting a mobile phone includes a base, opposing upright brackets extending from the base, and opposing upper and lower ridges extending between the upright brackets. The upright brackets have opposing curved ends for releasably engaging corners of the mobile phone. The case includes a sound reflecting member at one end of the base for concentrating and reflecting sound waves from the speaker of the mobile phone toward the user holding the phone.

### CROSS-REFERENCE TO RELATED APPLICATIONS

This application is a continuation of Ser. No. 15/719,305, filed Sep. 28, 2017, which application claims the benefit of U.S. Provisional Patent Application Ser. No. 62/400,637, filed Sep. 28, 2016, which is hereby incorporated by reference in its entirety

### BACKGROUND

### 1. Field

The disclosure of the present patent application relates generally to mobile phones, and particularly to a sound amplifying case for mobile phones.

### 2. Description of the Related Art

Mobile phones have become indispensable in our daily lives. It is not uncommon for consumers to own multiple mobile phones, such as one for personal use and one for work use. Due to their high portability, conventional mobile phones are typically lightweight, thin, and very compact. As conventional mobile phones have finite internal space, they cannot be equipped with a high-powered speaker. As a result, the speakers of most mobile phones can only produce low volume levels, which cannot easily be heard in an outdoor setting or a noisy environment. Oftentimes, the ringing sound of conventional mobile phones is so weak that important calls are often missed.

Thus, a sound amplifying case for mobile phones solving the aforementioned problems is desired.

### SUMMARY

A sound amplifying case for supporting a mobile phone includes a base, opposing upright brackets extending from the base, and opposing upper and lower ridges extending between the upright brackets. The upright brackets have opposing curved ends for releasably engaging corners of the mobile phone. The case includes a sound reflecting member at one end of the base for concentrating and reflecting sound waves from the speaker of the mobile phone toward the user holding the phone.

These and other features of the present disclosure will become readily apparent upon further review of the following specification and drawings.

### BRIEF DESCRIPTION OF THE DRAWINGS

FIG. 1: is an environmental, perspective view of a sound amplifying case for mobile phones.

FIG. 2: is a front view of the sound amplifying case for mobile phones.

FIG. 3: is a right side view of the sound amplifying case for mobile phones.

Similar reference characters denote corresponding features consistently throughout the attached drawings.

### DETAILED DESCRIPTION OF THE PREFERRED EMBODIMENTS

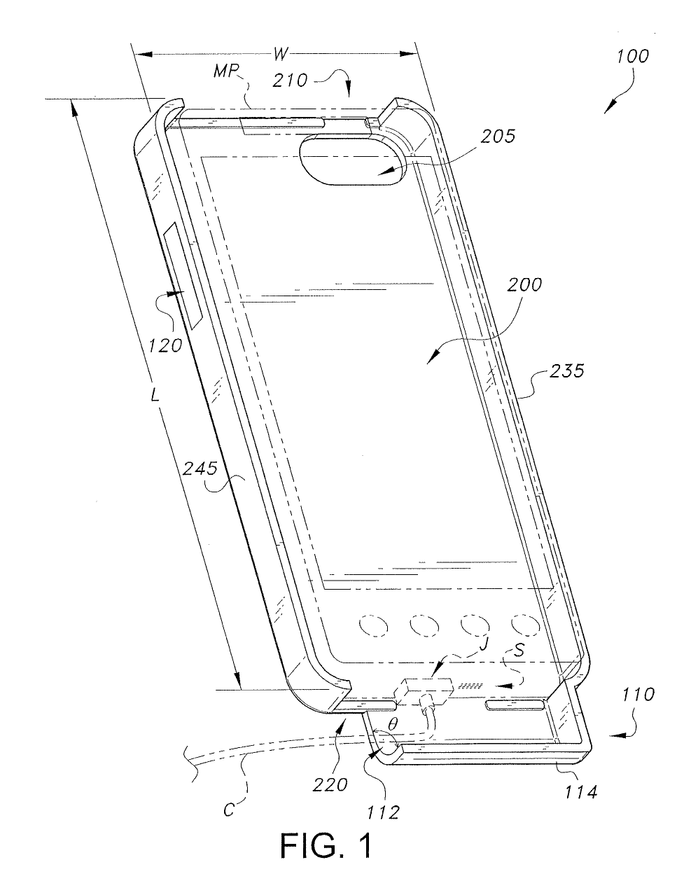

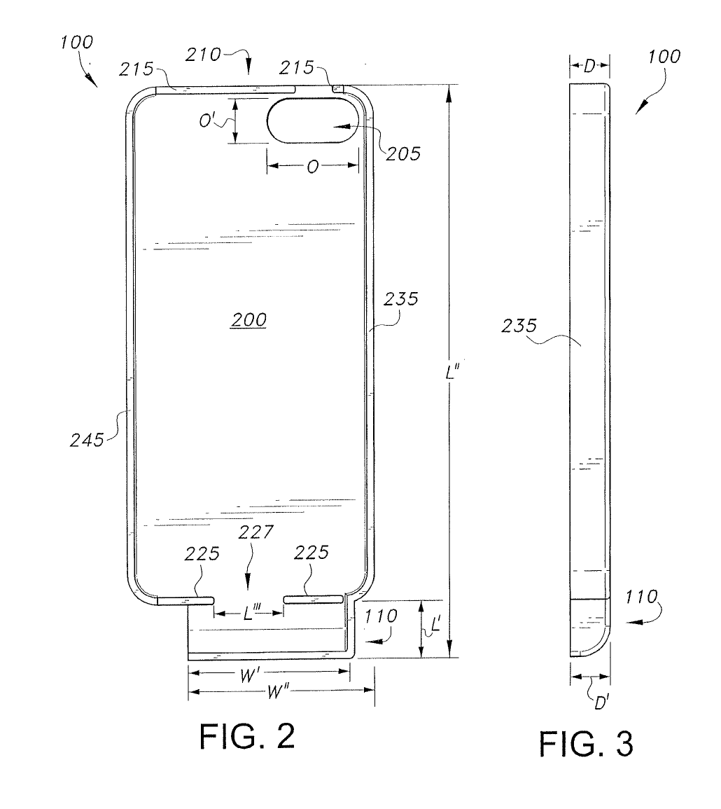

Referring to FIGS. 1 through 3, a sound amplifying case 100 for supporting a mobile phone MP is generally illustrated. The case 100 includes a base 200 and opposing upright brackets 235, 245 extending from the base 200. The base 200 can be generally rectangular. The upright brackets 235, 245 have opposing curved ends for releasably engaging corners of the mobile phone MP, e.g., snug fit attachment. Upper and lower ridges 215, 225 can extend between the upright brackets 235, 245 at opposing ends of the base. The upper and lower ridges 215, 225 can further secure the mobile phone MP in place. The ridges 215, 225 can have a lesser height than the sides 235, 245. The case 100 includes one or more surfaces for concentrating and reflecting sound waves from the speaker S of the mobile phone MP toward the user holding the phone. For example, the case 100 can include a sound reflecting member 110, as shown, to amplify sound emitted from the speaker S. The sound reflecting member 110 can be provided at a side of the case 100 which corresponds in position to the position of the speaker S of the mobile phone MP. In the embodiment shown, the mobile phone MP includes a speaker at a bottom edge thereof. As such, the sound reflecting member 110 is provided at a corresponding lower end 220 of the case 100. It should be understood, however, that the case 100 can be configured to include the sound reflecting member 110 at any side thereof to correspond to the speaker position of various mobile phone models.

The sound reflecting member 110 has a curved shape, such as a substantially curved shape, and extends from the lower end 220 of the base 200, as illustrated in FIGS. 1 through 3. The sound reflecting member 110 includes a floor 112 and a generally L-shaped, upright wall 114 extending at an angle θ from the floor 112. In an embodiment the angle θ can be approximately 90°. The upright wall 114 can include a first arm that is attached to the side 235 and a second arm that has a free or unattached end. The floor 112 and the upright wall 114 provide surfaces for concentrating and reflecting sound waves emitted from the speaker S, thereby amplifying the sound waves.

The case 100 can be formed from any suitable lightweight material, such as plastic, by any suitable process, such as injection molding. The case 100 can be formed from acrylonitrile butadiene styrene, for example. The case 100 can have any suitable dimensions suitable for receiving the mobile phone MP. In an embodiment, the case 100 can have a length L of about 4.87 in., a width W of about 2.37 in., and a depth D of about 0.36 in. It is to be noted that the length L, width W, and depth D of the case 100 may be modified accordingly so as to fit a variety of mobile phones having different dimensions.

Similarly, the sound reflecting member 110 can have any suitable dimensions. In an embodiment, the sound reflecting member 100 can have a length L′ of about 0.53 in., such that the total length L″ of the case 100 including the sound reflecting member 110 can be about 5.52 in. The sound reflecting member 110 can also have a width W′ of about 1.59 in. and depth D′ of about 0.26 in.

The upright bracket 245 may have an opening 120 which corresponds in position to the volume controls of the mobile phone MP. The ridge 220 may include an opening 227, e.g., having a length L′″ of about 0.68 in., which corresponds in position to the jack J of the mobile phone MP. The base 200 of the case 100 may also include an opening 205 corresponding in position to a lens (not shown) of a camera (not shown) positioned on the back side of the mobile phone MP. The opening 205 may have a length O of about 0.87 in. and a width O′ of about 0.43 in.

By way of operation, the mobile phone MP, is positioned in the case 100, such that the mobile phone MP is positioned between upright brackets 235, 245 and between the upper and lower ridges 215, 225. When the mobile phone MP is properly positioned in the case 100, the speaker S is spaced from the sound reflecting member 110 and positioned proximate the upright wall 114 of the sound reflecting member 110. Once the mobile phone MP has been correctly positioned in the case 100, any sound emitted from the speaker S can be concentrated and reflected toward the user by the sound reflecting member 110.

It is to be understood that the sound amplifying case for mobile phones is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A sound amplifying case for mobile phones, the case comprising:
a generally rectangular base;
a pair of opposing upright brackets extending from opposing sides of the base, the upright brackets having curved ends; and
a sound reflecting member extending from an end of the base, the sound reflecting member including a floor and an upright wall extending from the floor, the upright wall including a first arm and a second arm, the first arm being attached to one of the upright brackets and the second arm having a free end.

2. The sound amplifying case for mobile phones recited in claim 1, further comprising a pair of ridges, the ridges protruding from opposing ends of the base.

3. The sound amplifying case for mobile phones recited in claim 1, wherein the upright wall of the sound reflecting member is generally L-shaped.

4. The sound amplifying case for mobile phones recited in claim 1, wherein an angle between the floor and the upright wall of the sound reflecting member is approximately 90°.

5. The sound amplifying case for mobile phones recited in claim 4, wherein the lower ridge includes a slit therethrough.

6. The sound amplifying case for mobile phones recited in claim 1, wherein the case is formed from plastic.

7. The sound amplifying case for mobile phones recited in claim 6, wherein the plastic comprises acrylonitrile butadiene styrene.
